(19) United States
(12) Patent Application Publication
(10) Pub. No.: US 2009/0307147 A1
(43) Pub. Date: Dec. 10, 2009

(54) INVESTMENT PORTFOLIO ALLOCATION

(76) Inventor: Thomas H. Ruggie, Tavares, FL (US)

Correspondence Address: PATTERSON & SHERIDAN, L.L.P., 3040 POST OAK BOULEVARD, SUITE 1500, HOUSTON, TX, 77056, US

(21) Appl. No.: 12/136,745

(22) Filed: Jun. 10, 2008

(51) Int. Cl. G06Q 40/00

(52) U.S. Cl. 705/36 R

(57) ABSTRACT

A method and a system of allocating a lump sum of money for to continue asset growth while at the same time providing income with some asset preservation are disclosed. The method includes determining an amount for investing and an income to be periodically distributed over a given time period. Each periodic income distribution corresponds to a pool having a lifetime and bearing a projected rate of return over the pool's lifetime. The method also includes apportioning the amount into at least two sub-amounts assigned to at least two different pools such that each pool prospectively yields over the given time period the periodic distribution of income corresponding to that pool. Each pool invests the sub-amount into selected investment vehicles based on their risk of return suited for each pool's projected rate of return over the pool's lifetime.

### BACKGROUND OF THE INVENTION

1. Field of the Invention

Embodiments of the present invention generally relate to a method of managing investment assets for the purpose of providing future long term income while preventing complete exhausting of the investment assets.

2. Description of the Related Art

Retirement income planning is a daunting and challenging task. An individual must consider and account for numerous contingencies to ensure a sufficient and reliable income stream. In fact, to achieve and maintain a desired lifestyle after a person stops earning income from employment, an individual must be able to accurately forecast (or as close thereto as possible) his or her cost-of-living expenses and increases, unexpected expenses, such as medical and other emergencies, how long he or she will live, and other numerous speculative factors. Furthermore, given the rapidly rising cost-of-living and the fact that humans are living longer, healthier lives, it is paramount that an individual plan adequately for post-employment income. Many individuals save for retirement through various investment means such as 401(k) plans, IRAs, annuities, stocks, bonds, mutual funds, and pension plans. When thinking about a portfolio of investments, it is appropriate to consider all assets owned, including business assets and real property, arts, antiques, etc. Over the years, the amount in each asset generally increases, yielding a large total sum of money on which the individual may live during retirement years. However, depending upon the asset class, changes may need to be made. For example, business succession or sale of business or real property to provide funds for retirement may be critical to the financial planning process.

Retirement planning is particularly important today, given the uncertainty of long-term employment, the decline in traditional retirement plans and political uncertainty about the future and composition of social security. Add to this the fact that 76 million Baby Boomers, born between 1946 and 1964, are now reaching retirement age, and the importance of appropriate planning is critical.

Despite the years of savings and planning for retirement, an individual may be uncertain as to whether he or she set aside a sufficient amount for future post-employment living. Some individuals may wish to continue investing in various retirement accounts to maintain asset growth in order to ensure a sufficient amount for retirement living. However, in order to maintain asset growth that may keep pace with inflation, investment in higher risk vehicles may be necessary; the downside of which is greater risk in losing some of the original capital invested. Moreover, capital loss during post-employment living may jeopardize the individual's ability to provide for their and their family's economic needs. Alternatively, an individual may continue investing in various retirement accounts to preserve the original capital amount invested. However, preservation of the original capital amount is likely not possible if the individual must live off that capital, and if returns over the years on the initial investment are insufficient to provide a desired annual post-employment income income.

Consequently, there exists a need to continue asset growth while at the same time providing sufficient post-employment income with some asset preservation, particularly during retirement.

Other endeavors besides retirement may also require financial planning to ensure future income coupled with some asset preservation. For example, entities such as tax-exempt organizations or businesses may require large capital inflows and outflows for various present and future expenditures and may want to plan for unexpected future events. However, an entity's current capital outflow needs may exceed the capital amount necessary for them to adequately prepare for future known or unknown expenditures simultaneously. For instance, the spending of current capital may prevent the sufficient initial capital investment to cover an expected future expenditure.

Consequently, a need exists to help entities manage capital inflows with capital outflows by continuing asset growth while providing sufficient income with some asset preservation.

### SUMMARY OF THE INVENTION

The present invention generally relates to a method and a system of calculating continuous future payouts within desired terms by allocating an asset portfolio into different pools which invest in selected types of investment vehicles.

In one aspect of the invention, the method is for allocating a lump sum of money for investment to yield income over time. The method includes determining an amount for investing and determining an income to be periodically distributed over a given time period where each periodic income distribution corresponds to a pool having a lifetime and bearing a projected rate of return over the pool's lifetime. The amount is apportioned into at least two sub-amounts assigned to at least two different pools such that each pool prospectively yields over the given time period the periodic distribution of income that corresponds to that pool. Additionally, each pool invests the sub-amount into selected investment vehicles based on their risk of return suited for each pool's projected rate of return over the pool's lifetime.

In another aspect of the invention, the system includes a computer system having a user interface for an investor to enter data, including but not limited to an amount for investing, an income to be periodically distributed over a given time period corresponding to a pool, a projected rate of return for the pool, and a pool lifetime. The system also includes a display component that displays the data, and an executable program that is stored in the computer system for apportioning the amount for investing into sub-amounts assigned to the different pools, such that each pool prospectively yields over the given time period the periodic distribution of income corresponding to that pool.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating one embodiment of the method for allocating a lump sum for investing, according to the present invention.

FIG. 2 is a block diagram illustrating one embodiment of the method for allocating a lump sum amount for investing, according to the present invention.

FIG. 3 is a block diagram further illustrating the embodiment in FIG. 2 of the method for allocating a lump sum amount for investing, according to the present invention.

FIG. 4 is a block diagram illustrating the system for allocating a lump sum for investing, according to the present invention.

FIG. 5 illustrates an exemplary display that communicates an input/output data screen to the user, according to one embodiment of the present invention.

FIG. 6 illustrates an exemplary display that communicates an input/output data screen post calculation based on the user's input data, according to one embodiment of the present invention.

### DETAILED DESCRIPTION OF EMBODIMENTS OF THE PRESENT INVENTION

Embodiments of the present invention generally provide a method and a system for allocating a lump sum for investment in order to continue asset growth while yielding income over time with some asset preservation. In particular, the present invention allocates a lump sum of money into various pools in order to assist an individual in managing their assets to ensure a desired standard of post-employment living, such as retirement.

In one embodiment, assets are managed in a manner that provides a periodic income distribution to support the desired standard of living during retirement. Additionally, the present invention assists other entities such as tax-exempt organizations or businesses in managing their capital inflows and outflows to improve the likelihood that sufficient assets for present and future capital expenditures, either expected or unexpected, are available. Thus, applications of the present invention may be used to manage capital across a broader market than just individual post-employment income planning.

The present invention is somewhat contradictory to traditional retirement planning in which the pie-shaped allocation of assets increases in fixed income with age. Planners have thought that older people needed higher percentages of relatively low-risk investments in their portfolio—for example the rule of thumb suggested keeping the percentage of fixed income that matched your age. A 40 year old would have 40 percent in fixed income, while a 75 year old would have 75 percent in fixed income. The present invention however analyzes what amount of income the user needs in retirement in comparison to what he/she have available as income-producing investments. The process allows the user to improve the likelihood that income is available for the life of the user and beyond. This invention is more a needs-based approach than a simple age-based formula, which has been a traditional way of looking at retirement planning.

In short, the present invention assists a user in determining how to allocate a lump sum amount into various pools having different projected rates of return so that each pool may provide a desired periodic income over the pools' lifetime, while not extinguishing the initial capital amount.

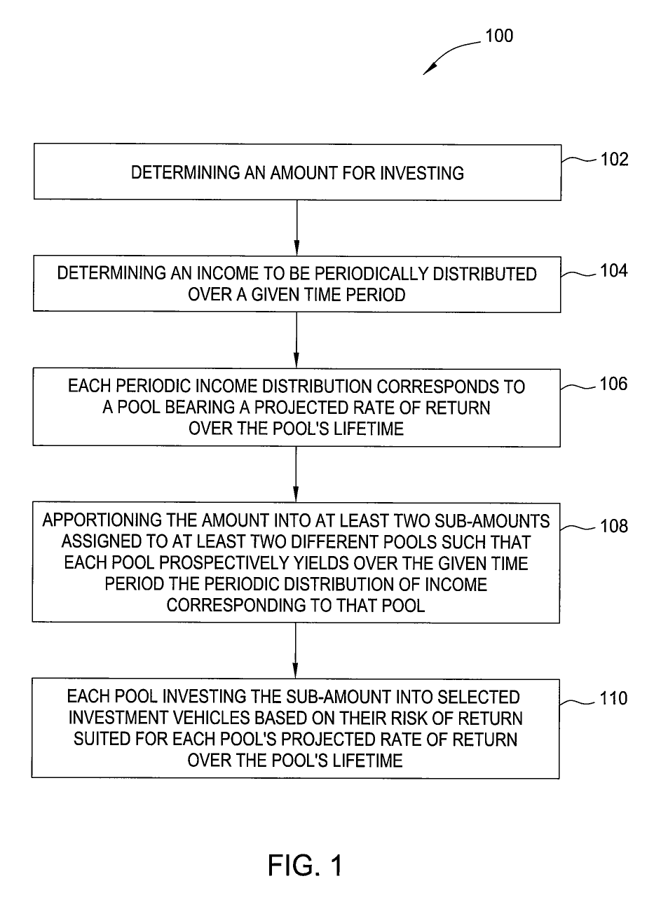

FIG. 1 is a flow diagram illustrating one embodiment of the method 100 for allocating a lump sum for investing, according to the present invention. The method 100 includes determining an amount for investing 102 and determining an income to be periodically distributed over a given time period 104. The income may be a monetary amount periodically distributed on a bi-weekly, monthly, yearly, or any other basis of time measurement. The given time period 104, over which the income is to be periodically distributed, may cover the entire lifetime of the pool or it may cover only some portion of the pool's lifetime. For example, if a pool had a lifetime of ten years and a periodic income distribution of $50,000 per year, the given time period for income distribution may be the pool lifetime of ten years, totaling $500,000 distributed over the pool's lifetime. Alternatively, the given time period may be five years, for example distributing the periodic income only over years 6-10 of the pool's lifetime. In that example, the total income distributed from the pool would be $250,000 over the pool's lifetime. Any portion of the pool's lifetime may be chosen for the given time period over which the income is to be distributed.

In any case, each periodic income distribution corresponds to a pool bearing a projected rate of return over the pool's lifetime 106. The method 100 further includes apportioning the amount into at least two sub-amounts assigned to at least two different pools such that each pool prospectively yields over the given time period the periodic distribution of income corresponding to that pool 108. Furthermore, each pool invests the sub-amount into selected investment vehicles based on their risk of return suited for each pool's projected rate of return over the pool's lifetime 110. The projected rate of return for one pool is preferably greater than another pool.

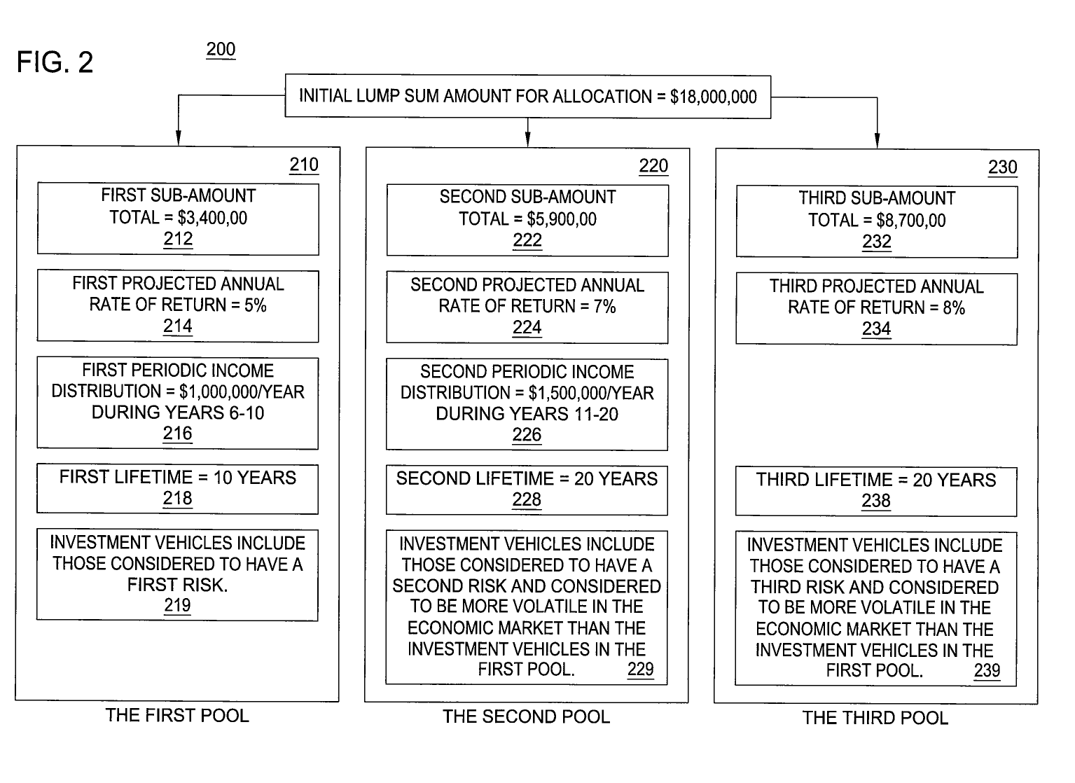

To better demonstrate the method described above, FIG. 2 illustrates a block diagram of one embodiment of the method for allocating a lump sum amount for investing, according to the present invention. The actual monetary amounts in this figure are only exemplary. In this embodiment, the initial lump sum amount 200 will be divided among three pools, a first pool 210, a second pool 220, and a third pool 230. A periodic income distribution 216 and 226 corresponds to pools 210 and 220. For example, the first pool 210 provides a first periodic income distribution 216 equal to $1,000,000 per year over a given time period, in this example, years 6-10. However, the given time period could be equal to the pool lifetime; the given time period variable may be selected by the investor according to their needs. The second pool 220 provides a second periodic income distribution 226 equal to $1,500,000 per year during years 11-20.

Each pool 210, 220, 230 also has a lifetime 218, 228, 238 and bears a projected rate of return 214, 224, 234 over the pool's lifetime. For example, the first pool has a projected rate of return 214 of 5% and a first lifetime 218 of ten years whereas second and third pools have second and third lifetimes of twenty years but different projected rates of return, 7% and 8% respectively. In this embodiment, the second and third lifetimes 228, 238 are longer than the first lifetime 218. Additionally, the second projected rate of return 224 is greater than the first projected rate of return 214 and the third projected rate of return 234 is greater than the second projected rate of return 224.

To achieve the projected rates of return corresponding to each pool, each pool contains various types of investment vehicles based on their risk of return suited for each pool's projected rate of return over the pool's lifetime. For example, the first pool 210 contains investment vehicles considered to have a first risk 219, thus yielding a projected rate of return 214 of 5%. Some economic experts may consider the first risk 219 to be very little compared to the risks associated with other investment vehicles. Whereas the second pool 220 contains investment vehicles considered to have a second risk 229 and considered to be more volatile in the economic market than the investment vehicles in the first pool 210, thus yielding a projected rate of return 224 of 7%. Some economic experts may consider the second risk 229 to be only modest compared to the risks associated with other investment vehicles. The third pool 230 contains investment vehicles considered to have a third risk 239 and considered to be more volatile in the economic market than the investment vehicles of the first pool 210, thus yielding a projected rate of return 234 of 8%. Some economic experts may even consider the investment vehicles in the third pool to be the most volatile in the economic market, but over time, that volatility may produce higher average rates of return. It should be noted that although each pool has a projected rate of return, the actual yearly rate of return may fluctuate as the market fluctuates. Thus, the investment vehicles may be diversified to provide an average rate of return that is at least equal to the projected rate of return over each pool year or over the pool's lifetime, in spite of individual investment vehicle's annual superior or inferior performance.

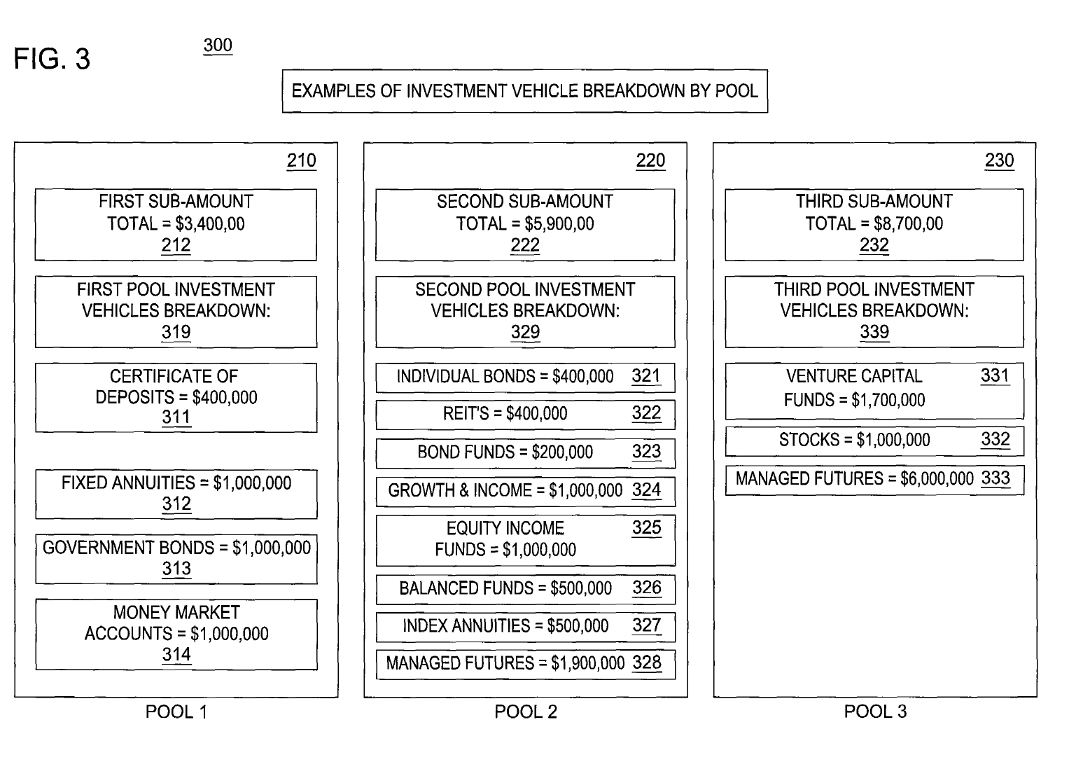

In order to provide each periodic income distribution 216, 226, 236 over their given time periods, the initial lump sum amount 200 equal to $18,000,000 is divided into three sub-amounts: a first sub-amount 212 equaling $3,400,000, a second sub-amount 222 equaling $5,900,000, and a third sub-amount 232 equaling $8,700,000. Each sub amount 212, 222, and 232 are assigned to the first, second, and third pools 210, 220, 230 respectively. An exemplary breakdown of the types of investment vehicles found in each pool is illustrated in FIG. 3.

FIG. 3 is a block diagram further illustrating the embodiment in FIG. 2 of the method for allocating a lump sum amount for investing, according to the present invention. As shown in FIG. 3, the first pool 210, the second pool 220, and the third pool 230 illustrate various investment vehicles that may be used to provide the projected annual rate of return as described above with reference to FIG. 2. The first pool 210 may be considered a pool that provides fixed income. As shown in FIG. 2, the first pool 210 contains investment vehicles considered to have a first risk 219, thus yielding a projected rate of return 214 of 5%, and a first sub-amount of $3,400,000.

The investment vehicles in the first pool may include for example, but are not limited to, cash certificates of deposit, fixed annuities, government bonds, money market accounts, bond funds, treasury notes, treasury bills, and combinations thereof. In the embodiment according to FIG. 3, the first sub-amount $3,400,000 of the first pool is divided among the first pool investment vehicles 319 according to the following amounts: certificate of deposits 311 equaling $400,000, fixed annuities 312 equaling $1,000,000, government bonds 313 equaling $1,000,000, and money market accounts 314 equaling $1,000,000.

As shown in FIG. 2, the second pool 220 contains investment vehicles considered to have a second risk and considered to be more volatile in the economic market than the investment vehicles in the first pool 229, thus yielding a projected rate of return 224 of 7%. The second pool 220 may have correlated, negatively correlated, or uncorrelated investments in order to provide a downside buffer and lessen systematic risk. The second pool investment vehicles may include for example, but are not limited to, individual bonds, real estate investment trusts, bond funds, growth and income funds, equity income funds, balanced funds, real estate, index annuities, structured notes, managed futures, and combinations thereof.

In the embodiment according to FIG. 3, the second sub-amount $5,900,000 of the second pool 220 is divided among the second pool investment vehicles 329 according to the following amounts: individual bonds 321 equaling $400,000, real estate investment trusts or REIT's 322 equaling $400,000, bond funds 323 equaling $200,000, growth and income funds 324 equaling $1,000,000, equity income funds 325 equaling $1,000,000, balanced funds 326 equaling $500,000, index annuities 327 equaling $500,000, and managed futures 328 equaling $1,900,000.

The third pool 230, as shown in FIG. 2, typically includes equity investments and contains investment vehicles considered to have a third risk and considered to be more volatile in the economic market than the investment vehicles in the first pool, thus yielding a projected rate of return 234 of 8%. The third pool investment vehicles may include for example, but are not limited to, stocks, mutual funds, venture capital funds, hedge funds, managed futures, real estate, real estate investment trusts and combinations thereof.

In the embodiment according to FIG. 3, the third sub-amount $8,700,000 of the third pool is divided among the third pool investment vehicles 339 according to the following amounts: venture capital funds 331 equaling $1,700,000, stocks 332 equaling $1,000,000, and managed futures 333 equaling $6,000,000. The types of investment vehicles in the second pool and the third pool may overlap some or he/she may not overlap at all, depending on the associated risk of each individual investment vehicle and its effect on the projected rate of return of the respective pools. For example, both pools two and three may have money invested in real estate investment trusts in one embodiment. In another embodiment, only one of the pools, if any, will invest in real estate investment trusts.

TABLE I

| | Beginning Value | End of Year 1 | End of Year 5 | End of Year 10 | End of Year 20 |
|---|---|---|---|---|---|
| The First Pool at 5% | $3,400,000 | $3,570,000 | $4,339,357 | $12,610 | $0 |
| The Second Pool at 7% | $5,900,000 | $6,313,000 | $8,275,055 | $11,606,193* | $58,967 |
| The Third Pool at 8% | $8,700,000 | $9,396,000 | $12,783,154 | $18,782,647 | $40,550,327 |
| Total Balance | $18,000,000 | $19,279,000 | $25,397,566 | $30,401,450 | $40,609,294 |

Distribution Schedule:
1) No distribution in years 1-5
2) Distribute $1,000,000 per year from the First Pool in years 6-10.
3) Distribute $1,500,000 per year from the Second Pool in years 11-20.
*Pool 2 projected rate resets to 5% after year 10
*Projected rates of return are assumptions and will vary on a year-to-year basis.

Table I illustrates the various pool amounts over the pools' lifetime, according to one embodiment of the present invention. Each pool begins with an initial investment total amount equal to its respective sub-amount as described and shown above. At the end of 5 years, each pool has a projected amount: the first pool equals $3,570,000, the second pool equals $6,313,000, and the third pool equals $12,783,154. During years 6-10 in this scenario, the first pool begins an annual income distribution of $1,000,000 per year. The remaining capital continues to be invested in the investment vehicles suited to bear a 5% projected rate of return as described above. By the end of year 10, the first pool is virtually depleted of its original capital investment amount with only a projected remainder of $12,610.

When the first pool's lifetime expires, the first pool subsequently liquidates with any first pool sub-amount remainder reassigned to the second pool. In this scenario as shown in Table I, $12,610 is added to the total capital investment in the second pool. Additionally, after liquidation of the first pool, the second projected rate of return is reduced with the second pool subsequently containing investment vehicles considered to have the first risk. For example, the second projected rate of return over years 11-20 is 5% and the total capital investment is reallocated among investment vehicles similar to those found in first pool. Thereafter, a second periodic income distribution corresponding to the second pool is dispensed over the remainder of the second lifetime. In this scenario, beginning in year 11 a second periodic income distribution of $1,500,000 per year is distributed over years 11-20.

When the second pool's lifetime expires, the second pool subsequently liquidates with any second pool sub-amount remainder reassigned to the third pool. In this scenario as shown in Table I, $58,967 is added to the total capital investment in the third pool. Additionally, after liquidation of the second pool, the third projected rate of return is reduced with the third pool subsequently containing investment vehicles considered to have the first risk if the third lifetime is greater than the second lifetime. For example, the third projected rate of return after year 20 is 5% and the total capital investment is reallocated among investment vehicles similar to those originally found in the first pool. Thereafter, a third periodic income distribution corresponding to the third pool is dispensed over the remainder of the third lifetime. If the third lifetime equals the second lifetime, then the third pool may be liquidated and the final lump sum of $40,609,294 returned to the investor.

In any of the above embodiments, an investor may select any of the following variables: the duration of the given time period, the projected rate of return for a pool, and the pool's lifetime. According to any of the selected variables, the method will allocate the lump sum amount in to the appropriate sub-amounts and assign them to the appropriate pool type to yield the chosen periodic distribution of income over the given time period. Moreover, the investments in the pools will be re-balanced periodically as circumstances require. Some examples of which may include, but are not limited to, the following: changes and fluctuations in the economic market, changes in an investor's income needs, past pool performance, inflation, changes in an investor's assets, death of the investor or family member and combinations thereof. Additionally, the periodic income distribution corresponding to each pool may be readjusted for inflation during the pool's lifetime.

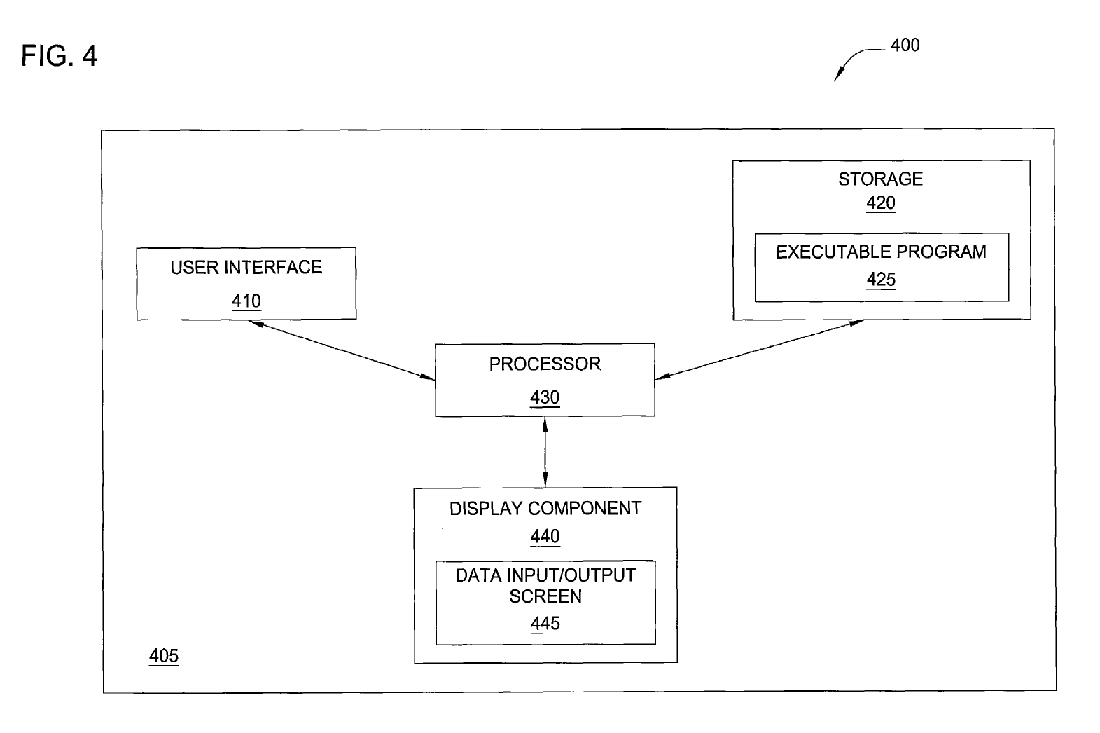

FIG. 4 is a block diagram illustrating the system 400 for allocating a lump sum for investing, according to the present invention. The system 400 includes a computer system 405 having a user interface 410 for an investor to enter data. The data may include but is not limited to an amount for investing, an income to be periodically distributed over a given time period corresponding to a pool, a projected rate of return for the pool, and a pool lifetime as described and shown above.

Additionally, the computer system 405 includes a display component 440 that displays the data such as a data input/output screen 445. The output may include tables, graphs, charts, etc. An executable program 425 stored in the computer system 405 that apportions the amount for investing into sub-amounts assigned to the different pools such that each pool prospectively yields over the given time period the periodic distribution of income corresponding to that pool. The executable program 425, such as an investment program, may be stored on a storage device 420, such as a hard drive.

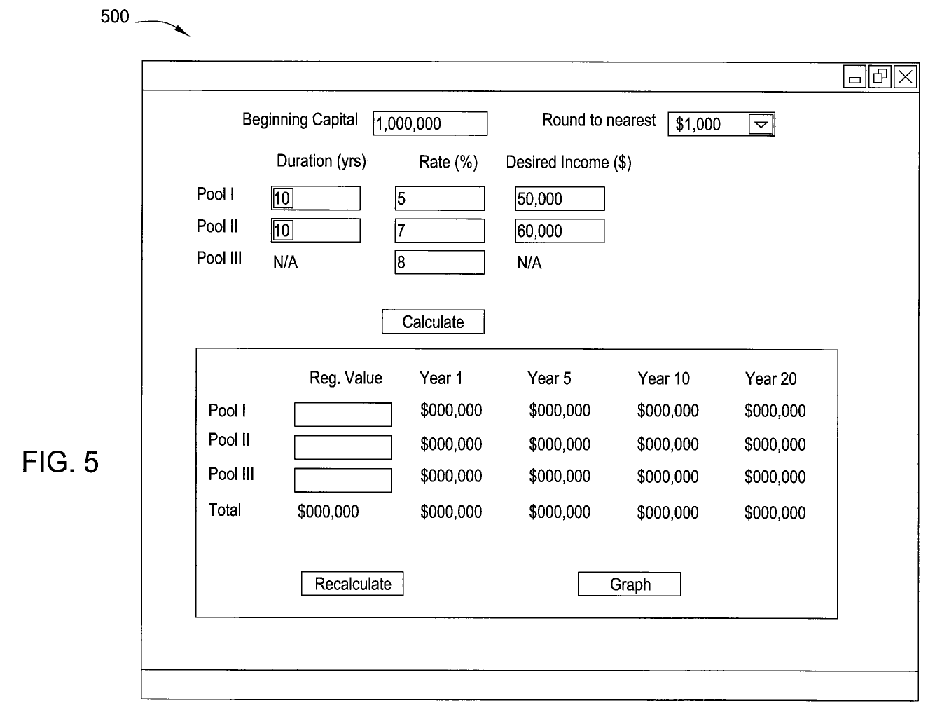

FIG. 5 illustrates an exemplary display 600 that presents an input/output data screen to the user, according to one embodiment of the present invention. The display 500 may show the input fields for an investor to enter data. For example, the beginning capital field permits the investor to determine the amount for investing, in this scenario, the amount is $1,000,000. The investor may also select the lifetime of each pool in the duration input field. In this example, the investor may not choose the third pool's lifetime, though in other embodiments this option is contemplated. Additionally, the total number of pools for investing may also be chosen by the investor. The investor may also choose a desired periodic income distribution corresponding to each pool. In other embodiments the investor may also select the given time period over which the periodic income distribution occurs. For example, the investor may select only certain years of the pool's lifetime or choose to receive income from the pool over its entire lifetime. Another variable that the investor may choose is the projected rate of return corresponding to each pool. After all the variables are entered into the data input fields by the investor, the calculate screen button is selected to initiate the programs allocation function.

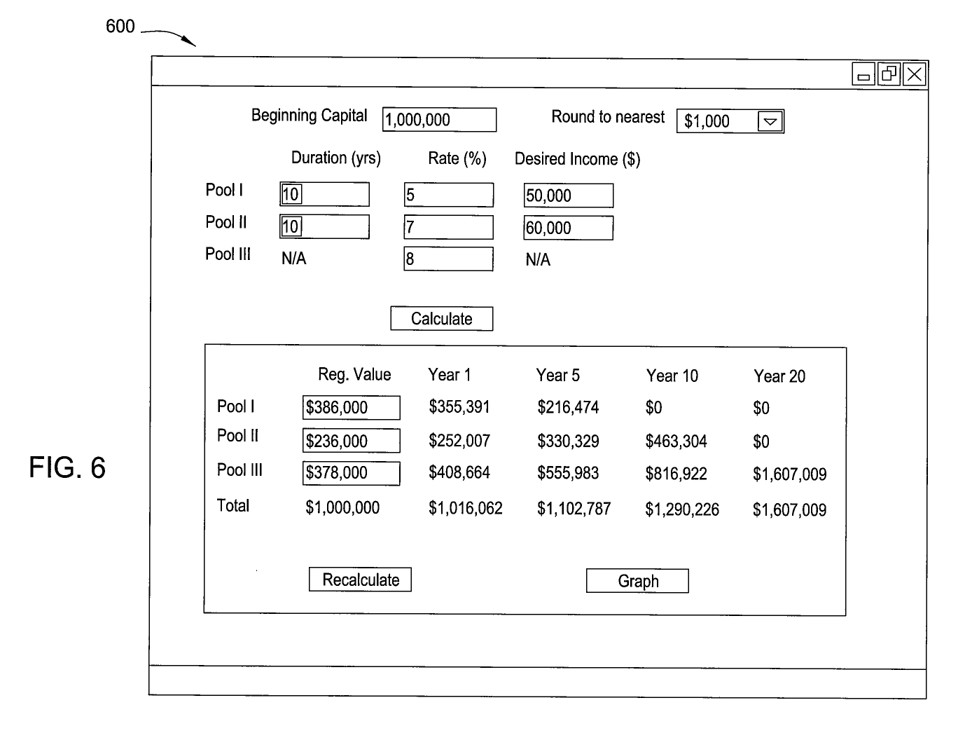

FIG. 6 illustrates an exemplary display 600 that communicates an input/output data screen to the user post calculation based on the user's input data, according to one embodiment of the present invention. The program allocates the initial lump sum amount among the various pools, such as in this scenario, first pool receives $386,000, the second pool receives $236,000, and the third pool receives $378,000. Based on those three sub-amounts assigned to the different pools, various year end projections of the capital in each pool may also be displayed. For instance, after year 1, $355,391 remains in the first pool which includes the $50,000 income distributed each year from the first pool and the 5% gain on the original capital sub-amount of $386,000. Meanwhile, the second and third pools have projected gains of 7% and 8% respectively during years 1-10 with no periodic income distributions.

After year 10, first pool is liquidated with any remaining amount of capital reassigned to the second pool. The projected rate of return on the second pool may be reset to 5% for years 11-20. The second pool then distributes $60,000 a year for the remaining lifetime of the second pool, in this scenario 10 years. At year 20, the second pool is liquidated with any remaining amount of capital reassigned to the third pool. The third pool than may continue to bear a projected rate of return over a lifetime that exceeds that of the second pool. Or, as in this scenario in FIG. 6, the third pool lifetime may be 20 years and the total capital remaining in the third pool may be liquidated and returned to the investor at the end of the 20 years.

The executable program may automatically reset the projected rates of return to lower rates as each pool liquidates upon lifetime expiration of another pool. For example, as part of the calculation to determine the allocation of the beginning lump sum amount into the sub-amounts, the program accounts for exhaustion of the first pool's capital at the end of year 10 and thus resets the second pool's projected rate of return to a lower amount similar or equal to the second pool's projected rate of return during years 11-20. This phase of the investment cycle of each pool may be termed a capital preservation phase. The system also provides for each pool to invest its sub-amount into selected investment vehicles based on their risk of return suited for each pool's projected rate of return over the pool's lifetime.

An investor may also readjust the desired periodic income distribution amounts, the projected rates of return on a pool, or the beginning capital amount and recalculate the allocation sub-amounts assigned to each pool. Changing those variables and selecting the recalculate screen button enables quick adjustment of the investment amounts, projected growth of capital over time, and unique personalization to the specific needs of each individual investor. Selecting the graph screen button will display the projected pool amounts over the course of their lifetimes in a graph form.

During retirement living, an investor may safely subsist on an original lump sum amount of money by using the disclosed method and system of allocating the lump sum amount between different investment pools. By sub-dividing the beginning lump sum amount between various pools having different rates of return, some having greater risk than the others, the investor may preserve some of the original asset amount while at the same time continue asset growth and provide sufficient post-employment income, particularly during retirement.

Moreover, although embodiments of present invention have been directed to personal retirement planning, other embodiments may be utilized for more than just personal retirement planning. In reality, applications of the present invention may be used to manage capital across a broader market. For example, businesses and tax-exempt entities may use embodiments of the present invention to manage capital inflows with capital outflows. For example, a municipality that has short, medium, and long-term needs could use embodiments of the present invention with safety and assurance to provide income for short-term needs, while planning for future long-term expenditures. In yet another example, a hospital foundation similarly could earmark projected needs with the investment pools as required for short, medium, and long-term projects. For instance, a hospital foundation could project the need for a new MRI in 5 years which may be funded by the second pool, while generating income with the first pool investments to meet an annual operating deficit. And if the hospital foundation projects the need for a new hospital in 15 years, the third pool could be earmarked to generate and provide funds to finance the new hospital's construction when the need arises in 15 years. In this example, the duration of a pool's lifetime may be shortened or lengthened to accommodate the time horizon of various projected needs.

While the foregoing is directed to embodiments of the present invention, other and further embodiments of the invention may be devised without departing from the basic scope thereof, and the scope thereof is determined by the claims that follow.

What is claimed is:

1. A method of allocating a lump sum of money for investment to yield income over time, the method comprising:
determining an amount for investing;
determining an income to be periodically distributed over a given time period, each periodic income distribution corresponding to a pool having a lifetime and bearing a projected rate of return over the lifetime of the pool;
apportioning the amount into at least two sub-amounts assigned to at least two different pools such that each pool prospectively yields over the given time period the periodic distribution of income corresponding to that pool, each pool investing the sub-amount in selected investment vehicles based on the risk of return of the investment vehicles suited for the projected rate of return over the lifetime of the pool.

2. The method of claim 1, wherein the projected rate of return for one pool is greater than another pool.

3. The method of claim 1, wherein the amount is apportioned into three sub-amounts assigned to three pools, the three pools comprising:
a first pool having a first lifetime and containing investment vehicles considered to have a first risk, the first pool bearing a first projected rate of return;
a second pool having a second lifetime longer than the first lifetime and containing investment vehicles considered to have a second risk and considered to be more volatile in the economic market than the investment vehicles in the first pool, the second pool bearing a second projected rate of return higher than the first projected rate of return; and
a third pool, having a third lifetime longer than the first lifetime and containing investment vehicles considered to have a third risk and considered to be more volatile in the economic market than the investment vehicles in the first pool, the pool bearing a third projected rate of return higher than the second projected rate of return.

4. The method of claim 3, wherein a first periodic income distribution corresponding to the first pool is dispensed over the first lifetime.

5. The method of claim 3, wherein the first pool liquidates at the end of the first lifetime with any first pool sub-amount remainder reassigned to the second pool.

6. The method of claim 5, wherein, after liquidation of the first pool, the second projected rate of return is reduced with the second pool subsequently containing investment vehicles considered to have the first risk.

7. The method of claim 5, wherein, after liquidation of the first pool, a second periodic income distribution corresponding to the second pool is dispensed over the remainder of the second lifetime.

8. The method of claim 3, wherein the second pool liquidates at the end of the second lifetime with any second pool sub-amount remainder reassigned to the third pool.

9. The method of claim 8, wherein, after liquidation of the second pool, the third projected rate of return is reduced with the third pool subsequently containing investment vehicles considered to have the first risk.

10. The method of claim 8, wherein, after liquidation of the second pool, a third periodic income distribution corresponding to the third pool is dispensed over the remainder of the third lifetime.

11. The method of claim 3, wherein the second lifetime equals the third lifetime.

12. The method of claim 3, wherein the investment vehicles of the first pool comprise cash, certificates of deposit, fixed annuities, government bonds, money market accounts, bond funds, treasury notes, treasury bills, or combinations thereof.

13. The method of claim 3, wherein the investment vehicles of the second pool comprise individual bonds, real estate investment trusts, bond funds, growth and income funds, equity income funds, balanced funds, real estate, index annuities, structured notes, or managed futures.

14. The method of claim 3 wherein the third pool investment vehicles comprise stocks, mutual funds, venture capital funds, hedge funds, managed funds, real estate, or real estate investment trusts.

15. The method of claim 1, wherein an investor selects the duration of the given time period, the projected rate of return for a pool, and the pool's lifetime or combinations thereof.

16. The method of claim 1, further comprising re-balancing investments in the pools in response to one or more events comprising changes and fluctuations in the economic market, changes in an investor's income needs, past pool performance, inflation, changes in an investor's assets, and combinations thereof.

17. The method of claim 1, further comprising readjusting the periodic income distribution for inflation.

18. A system for allocating a lump sum investment, the system comprising:
a computer system having a user interface for an investor to enter data, the data comprising an amount for investing, an income to be periodically distributed over a given time period corresponding to a pool, a projected rate of return for the pool, and a lifetime of the pool;
a display component that displays the data,
and an executable program, stored in the computer system that apportions the amount for investing into at least two sub-amounts assigned to at least two different pools such that each pool prospectively yields over the given time period the periodic distribution of income corresponding to that pool.

19. The system of claim 20 wherein each pool invests the sub-amount into selected investment vehicles based on their risk of return suited for each pool's projected rate of return over the pool's lifetime.

20. The system of claim 20 wherein the investor selects the number of pools.
